(19) United States
(12) Patent Application Publication
(10) Pub. No.: US 2007/0089423 A1
(43) Pub. Date: Apr. 26, 2007

(54) Gas turbine engine system and method of operating the same

(76) Inventors: Bruce Gordon Norman, Charlton, NY (US); Mohamed Ahmed Ali, Clifton Park, NY (US); Narendra Digamber Joshi, Cincinnati, OH (US); Sherif Hatem Abdulla Mohamed, Niskayuna, NY (US)

Correspondence Address: Patrick S. Yoder;FLETCHER YODER, P.O. Box 692289, Houston, TX, 77269-2289, US

(21) Appl. No.: 11/362,306

(22) Filed: Feb. 24, 2006

Related U.S. Application Data
(60) Provisional application No. 60/729,519, filed on Oct. 24, 2005.

(51) Int. Cl. F02C 7/12

(52) U.S. Cl. 60/772; 60/728; 60/736

(57) ABSTRACT

A gas turbine engine system includes an intercooler coupled between a low-pressure compressor and a high-pressure compressor and configured to cool the compressed air exiting the low-pressure compressor. Liquid natural gas or a cooled intermediate working fluid is used in the intercooler to cool the compressed air exiting the low-pressure compressor. A mixture of fuel and compressed air from the high-pressure are combusted in a combustion chamber of an engine. A turbine is coupled to the engine and configured to expand combustion exhaust gas ejected from the engine to generate power. A heat exchanger is coupled to the turbine and the intercooler and configured to re-gasify the liquid natural gas. The exhaust air exiting the turbine or a heated intermediate working fluid is used to gasify the liquid natural gas in the heat exchanger.

### CROSS REFERENCE TO RELATED APPLICATIONS

This application claims the benefit of U.S. Provisional Application No. 60/729,519 filed on Oct. 24, 2005, which is incorporated herein in its entirety by reference.

### BACKGROUND

The present invention, in accordance with certain exemplary embodiments, relates generally to gas turbine engine systems and methods of operating a gas turbine engine system. As particular examples, the present invention provides a system and method for cooling compressed air using liquid natural gas and re-gasifying the liquid natural gas.

Generally, in a gas turbine engine system, air is compressed in a compressor or a multi-stage compressor. Compressed air is mixed with fuel such as propane, natural gas, kerosene, jet fuel, or the like and combusted in a combustion chamber. Exhaust gas generated due to combustion is used to drive a turbine, which may be used to generate power or effectuate rotation. During warm days, the gas turbine's performance may be reduced due to elevated air temperature at an inlet of the compressor. The engine efficiency may be enhanced by intercooling air between the compressor stages. Traditionally, cooling towers are used to perform intercooling of air between the compressor stages.

Traditionally, trans-ocean transportation of natural gas from its source to a usage facility entails the following steps: Liquification of the natural gas in a liquifaction plant located near the natural gas resource, shipment of the liquid natural gas (LNG) to the destination, and re-gasificaton of the LNG in devices known as vaporizers. Once vaporized, the natural gas may be used as a fuel source, such as a fuel for a gas turbine. Various LNG vaporizers have either been used or demonstrated in LNG re-gasification plants. Commonly used LNG vaporizers include open rack vaporizers (ORV) and submerged combustion vaporizers (SCV). In an open rack vaporizer, seawater is used as a heating medium in a counter flow pattern to heat the LNG flowing inside the vaporizer tubes. In a submerged combustion vaporizer, a portion of the LNG (typically 1-3%) is combusted with air to generate hot combustion gases. The combustion gases are then bubbled through a water bath where the vaporizer tubes are submerged. However, open rack vaporizers and submerged combustion vaporizers have drawbacks, such as high cost factors, detrimental environmental impact, or the like.

Therefore, there is a need for an enhanced system and method for cooling compressed air and re-gasifying the liquid natural gas.

### BRIEF DESCRIPTION

In accordance with one aspect of the present invention, a method of operating a gas turbine engine system is provided. The method includes compressing an inlet air flow via a first compressor to produce a first outlet air flow at a first pressure. The first outlet air flow exiting the first compressor is cooled via an intercooler to produce a second outlet air flow. Liquid natural gas is used in the intercooler to cool the first outlet air flow. The second outlet air flow exiting the intercooler is compressed to produce a third outlet air flow at a second pressure via a second compressor. A mixture of fuel and the third outlet air flow exiting the second compressor is combusted. Combustion exhaust gas is expanded via a turbine to generate power. The liquid natural gas exiting the intercooler is re-gasified via a heat exchanger. Exhaust air exiting the turbine is used to gasify the liquid natural gas via the heat exchanger.

In accordance with another aspect of the present invention, a method of operating a gas turbine engine system is provided. The method includes compressing an inlet air flow via a first compressor to produce a first outlet air flow at a first pressure. The first outlet air flow exiting the first compressor is cooled via an intercooler to produce a second outlet air flow. A cooled intermediate working fluid is used in the intercooler to cool the first outlet air flow. The second outlet air flow exiting the intercooler is compressed to produce a third outlet air flow at a second pressure via a second compressor. A mixture of fuel and the third outlet air flow exiting the second compressor is combusted. Combustion exhaust gas is expanded via a turbine to generate power. The liquid natural gas is re-gasified via a heat exchanger. A heated intermediate working fluid exiting a working fluid heater is used to gasify the liquid natural gas via the heat exchanger.

In accordance with another aspect of the present invention, a gas turbine engine system is provided. A first compressor is configured to compress an inlet air flow to produce a first outlet air flow at a first pressure. An intercooler is coupled to the first compressor and configured to cool the first outlet air flow exiting the first compressor to produce a second outlet air flow. Liquid natural gas is used in the intercooler to cool the first outlet air flow. A second compressor is coupled to the intercooler and configured to compress the second outlet air flow exiting the intercooler to produce a third outlet air flow at a second pressure.

In accordance with another aspect of the present invention, a gas turbine engine system is provided. A first compressor is configured to compress an inlet air flow to produce a first outlet air flow at a first pressure. An intercooler is coupled to the first compressor and configured to cool the first outlet air flow exiting the first compressor to produce a second outlet air flow. A cooled intermediate cooled working fluid is used in the intercooler to cool the first outlet air flow. A second compressor is coupled to the intercooler and configured to compress the second outlet air flow exiting the intercooler to produce a third outlet air flow at a second pressure. A combustor is coupled to the second compressor and configured to combust a mixture of fuel and the third outlet air flow exiting the second compressor. A turbine is coupled to the combustor and configured to expand combustion exhaust gases.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatical representation of a gas turbine engine system having inter-cooling and waste heat recovery features, in accordance with an exemplary aspect of the present invention;

FIG. 2 is a diagrammatical representation of a gas turbine engine system having inlet air cooling, inter-cooling, and waste heat recovery features, in accordance with an exemplary aspect of the present invention; and

FIG. 3 is a diagrammatical representation of a gas turbine engine system having inlet air cooling, intercooling, and waste heat recovery features, in accordance with another exemplary aspect of the present invention.

### DETAILED DESCRIPTION

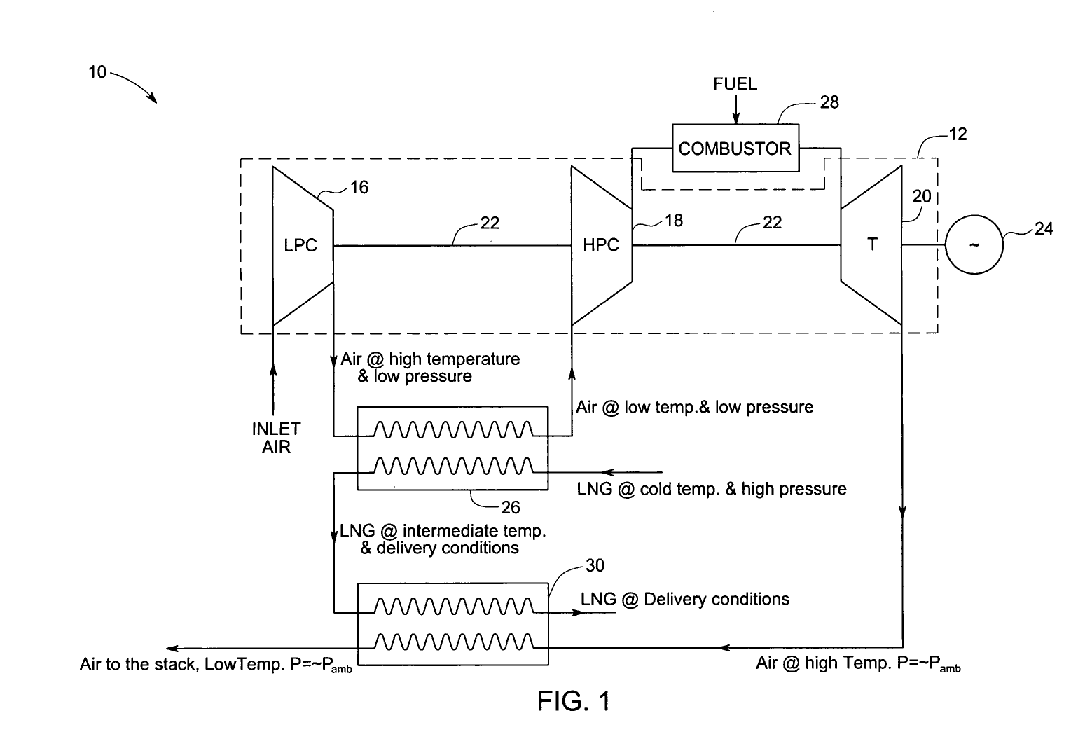

As discussed in detail below, embodiments of the present invention provide a gas turbine engine system, in which inlet air is compressed to higher pressures before being combusted with a fuel (for example, natural gas). Combustion products at high pressure and temperature are expanded through a turbine to generate power. Due to thermodynamic and gas dynamics considerations, combustion exhaust gases exit the turbine at relatively high temperature. The gas turbine engine system, in accordance with the aspects of the present invention, facilitates chilling of inlet air before compression, inter-cooling the air between compressor stages, and recover waste heat of the exhaust gas exiting the turbine. Liquid natural gas or a cooled intermediate working fluid is used as a coolant to extract heat. In certain exemplary embodiments, techniques in accordance with aspects of the present invention are disclosed in which liquid natural gas or the cooled intermediate working fluid is used for chilling inlet air before compression, and for cooling air between compressor stages via an intercooler. Techniques are also disclosed for recovering heat from turbine exhaust gas for heating the liquid natural gas using a heated intermediate working fluid. This combined power and natural gas re-gasification improves the overall efficiency of gas turbine system while meeting the required liquid natural gas delivery conditions. Embodiments of these techniques are discussed in further detail below with reference to FIGS. 1-3.

Referring to FIG. 1, an exemplary gas turbine engine system 10 is illustrated. The gas turbine engine system 10 in accordance with the aspects of the present invention includes a gas turbine engine 12. The gas turbine engine 12 includes a first compressor (i.e. low-pressure compressor) 16, a second compressor (i.e. high-pressure compressor) 18 and a turbine 20 mutually coupled via a gas turbine shaft 22. The high-pressure compressor 18 is coupled to a combustor 28. An outlet of the combustor 28 is coupled an inlet of the turbine 20. The turbine 20 is coupled to an exhaust manifold of the engine 12. A load generator unit 24 is mechanically coupled to the turbine 20. The gas turbine engine 12 is operated to maintain the load generator unit 24 at desired speed and load. Of course, the illustrated engine system is merely an example, as the present invention affords benefits to any number of systems in which the dissipation of heat is a concern.

The low-pressure compressor 16 draws inlet air (i.e. ambient air) through a filter (not shown) and compresses air to produce a first outlet air flow at a first pressure. The temperature of air is increased due to compression. The gas turbine engine system 10 includes an intercooler 26 coupled between the low-pressure compressor 16 and the high-pressure compressor 18. The compressed air (i.e. first outlet air flow) from the low-pressure compressor 16 is passed through the intercooler 26. During operation, the compressed air flows through the intercooler 26 such that the temperature of air is reduced prior to delivery into the high-pressure compressor 18. In the exemplary embodiment, liquid natural gas (for example, at a temperature of −160 degrees Celsius) is utilized to facilitate removal of heat from the compressed air to produce a second outlet air flow. The cooled compressed air (i.e. second outlet air flow) from the intercooler 26 is fed to the high-pressure compressor 18. The high-pressure compressor 18 is configured to compress the cooled air to produce a third outlet air flow at a second pressure that is higher than the first pressure.

A mixture of compressed air (i.e. third outlet air flow) from the high-pressure compressor 18 and a fuel (e.g. natural gas) are combusted within the combustor 28 of the engine to increase the temperature of the third outlet air flow. The combustion exhaust gas from the combustor 28 is fed to the turbine 20. The turbine 20 extracts energy by expansion of the exhaust gas for rotating the gas turbine shaft 22 coupled to the compressors 16, 18. The expanded gases (usually in the range of 300 to 650 degrees Celsius) are discharged through an outlet of the turbine 20.

The liquid natural gas is used as coolant in the intercooler 26 to facilitate removal of heat from the compressed air provided by the low-pressure compressor 16. While compressed air from the low-pressure compressor stage 16 is cooled before it enters the high-pressure compressor stage 18; the liquid natural gas is heated. Resultantly, the liquid natural gas is converted into gas. In addition to the inter-cooling mentioned above, the natural gas exiting the intercooler 26 may be used to recover the heat available in the exhaust gas ejected from the turbine 18 via a heat exchanger 30. The liquid natural gas is used to recover the exhaust heat (otherwise wasted) by cooling the exhaust gas stream from the turbine 20 to ambient temperature or to even less than ambient temperature while heating the liquid natural gas. The condensation energy in the exhaust stream from the turbine 20 may also be recovered since the liquid natural gas at preferred delivery temperature is generally less than the nominal ambient temperature. The liquid natural gas at preferred delivery temperature from the heat exchanger 30 may then be fed to a utility device such as a gas turbine engine or a pipeline as known to those skilled in the art. The low temperature exhaust gas stream from the heat exchanger 30 may be released to atmosphere via a stack.

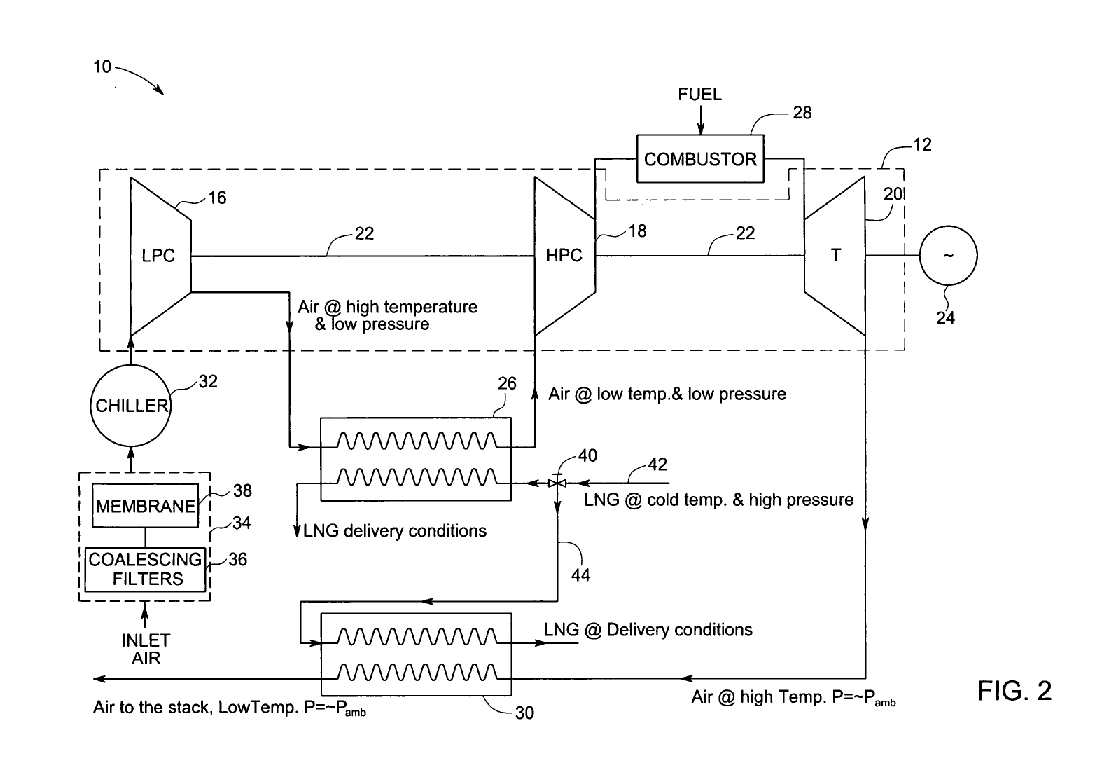

Referring now to FIG. 2, a gas turbine engine system 10 is illustrated in accordance with another exemplary embodiment of the present invention. In the illustrated embodiment, a chiller 32 is coupled to the low-pressure compressor 16 and configured to cool the inlet air supplied to the low-pressure compressor 16. Typically, gas turbine engine systems produces output horsepower that is proportional to combustion air mass flow. If the inlet air temperature is high, power output is substantially reduced. Engine output may be improved by reducing the temperature of inlet air at the low-pressure compressor inlet to increase the air density. When the gas turbine engine is used in a power plant, the increased engine output increases the power generation capacity. Inlet air chilling in accordance with the aspects of the present invention, is utilized to increase the power output during warmer days when maximum engine performance is required.

As known to those skilled in the art, in one example, the chiller 32 reduces the operating temperature of the inlet air. In the illustrated embodiment, an air dryer 34 is provided to an upstream side of the chiller 32. In one example, the dryer 34 includes a plurality of coalescing filters 36, and a membrane 38. The coalescing filter 36 may include a filter element provided inside a housing. The filter element may generally include an inner coalescing layer and an outer coarse drainage layer. Coalescing is a process in which liquid aerosols and droplets are removed from gas. The inner coalescing layer captures the fine liquid aerosols and droplets from the gas passed through the filter element. The fine liquid aerosols and droplets together form large droplets within the filter element. The large droplets are forced through the filter element and then drained into the housing of the filter 36 by gravity effect. The inlet air is passed through the membrane 38 to further remove moisture from the air. The membrane 38 may be a fiber membrane or a texture membrane as known to those skilled in the art. The membrane 38 is adapted to lower the dew point of inlet air to facilitate the removal of water vapor. The low-pressure compressor 16 draws the cooled inlet air from the chiller 32 and compresses the air to a first pressure. As a result, the temperature of air is increased due to compression. In another exemplary embodiment, the air dryer 34 may be provided between the chiller 32 and the low-pressure compressor 16. In yet another exemplary embodiment, the air dryer 34 may be provided between the low-pressure compressor 16 and the intercooler 26. As result, condensation of water vapor is prevented when the compressed air is further cooled inside the inter-cooler 26.

As discussed previously, during operation of the system 10, the compressed air flows through the intercooler 26 such that the temperature of air is reduced prior to delivery into the high-pressure compressor 18. Liquid natural gas is utilized to facilitate inter-cooling of the compressed air between the low-pressure compressor 16 and the high-pressure compressor 18. The cooled compressed air from the intercooler 26 is fed to the high-pressure compressor 18. The high-pressure compressor 18 is configured to compress the cooled air to a second pressure that is higher than the first pressure.

The mixture of compressed air from the high-pressure compressor 18 and a fuel are combusted within the combustor 28 of the engine. The combustion exhaust gas from the combustor is fed to the turbine 20. The turbine 20 extracts energy from the exhaust gas for rotating the gas turbine shaft 22 coupled to the compressors 16, 18 and the load generator unit 24. While compressed air from the low-pressure compressor 16 is cooled before it enters the high-pressure compressor 18; the liquid natural gas is heated in the inter-cooler 26. As a result, the liquid natural gas is converted into gas for delivery.

In an alternate exemplary embodiment, a by-pass valve 40 may be provided in the LNG supply pipe 42 coupled to the intercooler 26. The by-pass valve 40 is adapted to supply a portion of the liquid natural gas via a by-pass path 44 to the heat exchanger 30. The liquid natural gas is used to recover the exhaust heat (otherwise wasted) by cooling the exhaust gas stream from the turbine 20 to ambient temperature or to even less than ambient temperature while heating the liquid natural gas. The condensation energy in the exhaust stream from the turbine 20 may also be recovered since the liquid natural gas at preferred delivery temperature is generally less than the nominal ambient temperature.

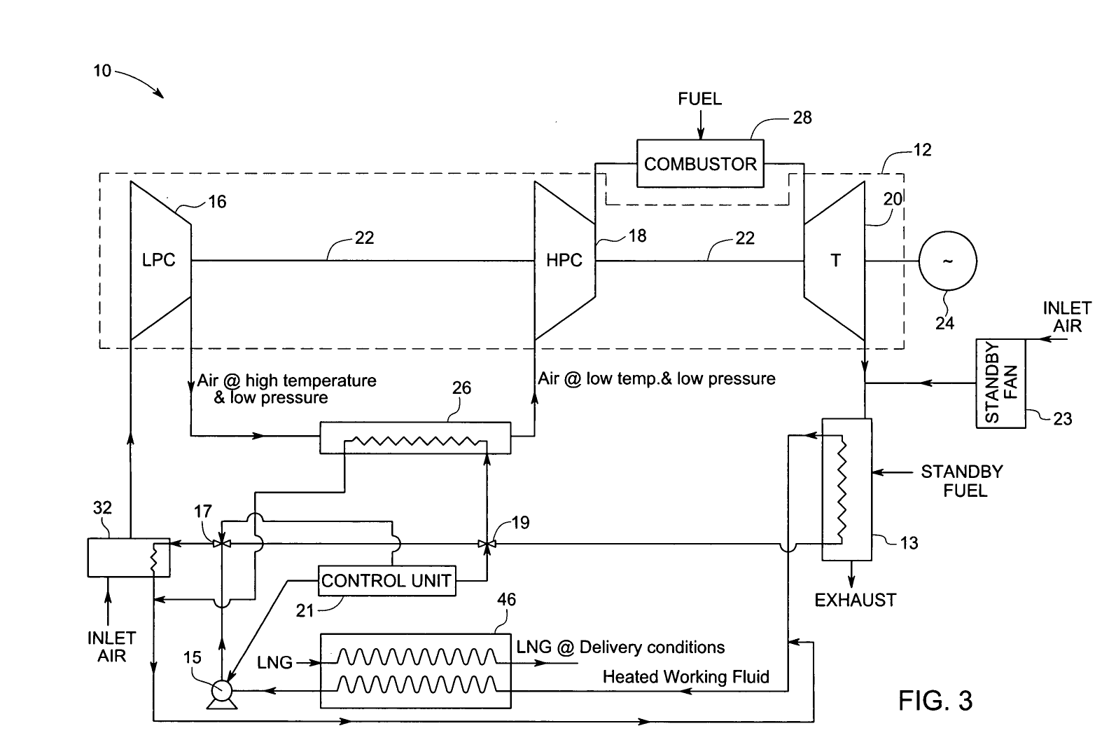

Referring to FIG. 3, a gas turbine engine system 10 is illustrated in accordance with another exemplary embodiment of the present invention. In the illustrated embodiment, the chiller 32 is coupled to the low-pressure compressor 16 and configured to cool the inlet air supplied to the low-pressure compressor 16. As discussed above, inlet air chilling in accordance with the aspects of the present invention, is utilized to increase the power output during warmer days when maximum engine performance is required.

The low-pressure compressor 16 draws cooled inlet air and compresses the air to a first pressure. As a result, the temperature of air is increased due to compression. During operation of the system 10, the compressed air flows through the intercooler 26 such that the temperature of air is reduced prior to delivery into the high-pressure compressor 18. In the illustrated embodiment, a cooled intermediate working fluid is utilized to facilitate inter-cooling of the compressed air between the low-pressure compressor 16 and the high-pressure compressor 18. The cooled compressed air from the intercooler 26 is fed to the high-pressure compressor 18. The high-pressure compressor 18 is configured to compress the cooled air to a second pressure that is higher than the first pressure.

The mixture of compressed air from the high-pressure compressor 18 and a fuel are combusted within the combustor 28 of the engine. The combustion exhaust gas from the combustor is fed to the turbine 20. The turbine 20 extracts energy from the exhaust gas for rotating the gas turbine shaft 22 coupled to the compressors 16, 18 and load generator unit 24. In the illustrated embodiment, a working fluid heater 13 is coupled to the turbine 20 and configured to receive the exhaust air from the turbine 20. The heater 13 may be equipped with gas burners for heating a mixture of exhaust air from the turbine 20 and a fuel such as methanol, ethanol, natural gas, or the like to produce a heated intermediate working fluid. The heated working fluid is passed though a heat exchanger 46. Liquid natural gas is used to recover the heat available in the heated working fluid ejected from the heater 13 via the heat exchanger 46. The liquid natural gas is used to recover the exhaust heat (otherwise wasted) by cooling the heated intermediate working fluid from the heater 13 to ambient temperature or to even less than ambient temperature while heating the liquid natural gas. As a result, the liquid natural gas is gasified.

In the illustrated embodiment, a standby fan 23 may be used to drive air into the heater 13 equipped with gas burners to be fired in case when the gas turbine is shut down for maintenance reasons or other reasons as known to those skilled in the art. A damper valve (not shown) facilitates to shut down the pathway from the turbine 20 to the heater 13. During turbine maintenance, a mixture of fuel and air from the standby fan 23 are burned within the heater 13 to produce the heated intermediate working fluid.

A working fluid pump 15 is utilized to pump the cooled intermediate working fluid through the chiller 32, intercooler 26, and the heater 13. In the illustrated embodiment, the cooled intermediate working fluid is utilized to cool the inlet air via the chiller 32. Also, the cooled intermediate working fluid facilitates cooling of compressed air exiting the low-pressure compressor 16 via the intercooler 26. A plurality of distribution valves 17, 19 are provided in the flow paths extending between heat exchanger 46, chiller 32, intercooler 26, and the heater 13. The distribution valves 17, 19 are configured to control the flow of cooled intermediate working fluid through the chiller 32, intercooler 26, and the heater 13. The cooled intermediate working fluid is heated via the chiller 32, intercooler 26, and the heater 13.

A control unit 21 is communicatively coupled to the distribution valves 17, 19, and the pump 15. The control unit 21 controls the operation of the valves and the pump 15 based on the ambient air temperature, mass flow of the LNG to be gasified and the gas turbine operating conditions. The control unit 21 may include a processor having hardware circuitry and/or software that facilitates the processing of signals from a sensor (not shown) configured to detect temperature of ambient air. As will be appreciated by those skilled in the art, the processor may comprise a microprocessor, a programmable logic controller, a logic module or the like.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of operating a gas turbine engine system, comprising:
compressing an inlet air flow via a first compressor to produce a first outlet air flow at a first pressure;
cooling the first outlet air flow exiting the first compressor via an intercooler to produce a second outlet air flow; wherein a liquid natural gas is used in the intercooler to cool the first outlet air flow; and
compressing the second outlet air flow exiting the intercooler to produce a third outlet air flow at a second pressure via a second compressor;
combusting a mixture of fuel and the third outlet air flow exiting the second compressor to increase an operating temperature of the third outlet air flow;
expanding a combustion exhaust gas via a turbine to generate power; and
gasifying the liquid natural gas via a heat exchanger using exhaust air exiting the turbine.

2. The method of claim 1, further comprising cooling the inlet air flow via a chiller using the liquid natural gas.

3. The method of claim 2, further comprising removing water vapor from the inlet air flow exiting the chiller via an air dryer.

4. The method of claim 1, further comprising driving the first compressor and the second compressor via the turbine.

5. A method of operating a gas turbine engine system, comprising:
compressing an inlet air flow via a first compressor to produce a first outlet air flow at a first pressure;
cooling the first outlet air flow exiting the first compressor via an intercooler to produce a second outlet air flow; wherein a cooled intermediate working fluid is used in the intercooler to cool the first outlet air flow;
compressing the second outlet air flow exiting the intercooler to produce a third outlet air flow at a second pressure via a second compressor;
combusting a mixture of fuel and the third outlet air flow exiting the second compressor to increase an operating temperature of the third outlet air flow;
expanding a combustion exhaust gas via a turbine to generate power; and
gasifying the liquid natural gas via a heat exchanger using a heated intermediate working fluid exiting a working fluid heater.

6. The method of claim 5, further comprising cooling the inlet air flow via a chiller using the cooled intermediate working fluid.

7. The method of claim 6, further comprising heating the cooled intermediate working fluid via the chiller.

8. The method of claim 5, further comprising heating the cooled intermediate working fluid via the intercooler.

9. The method of claim 5, further comprising heating the cooled intermediate working fluid via the working fluid heater.

10. The method of claim 5, further comprising driving the first compressor and the second compressor via the turbine.

11. A gas turbine engine system, comprising:
a first compressor configured to compress an inlet air flow to produce a first outlet air flow at a first pressure;
an intercooler coupled to the first compressor and configured to cool the first outlet air flow exiting the first compressor to produce a second outlet air flow; wherein a liquid natural gas is used in the intercooler to cool the first outlet air flow;
a second compressor coupled to the intercooler and configured to compress the second outlet air flow exiting the intercooler to produce a third outlet air flow at a second pressure;
a combustor coupled to the second compressor and configured to combust a mixture of fuel and the third outlet air flow exiting the second compressor to increase an operating temperature of the third outlet air flow; and
a turbine coupled to the combustor and configured to expand combustion exhaust gas exiting from the combustor to generate power.

12. The system of claim 11, further comprising a chiller coupled to the first compressor and configured to cool the inlet air flow directed to the first compressor using the liquid natural gas.

13. The system of claim 12, further comprising an air dryer coupled to the chiller and configured to remove water vapor from the air flow exiting the chiller.

14. The system of claim 11, wherein the turbine is coupled to the first and second compressor and configured to drive the first and second compressor.

15. The system of claim 14, further comprising a heat exchanger coupled to the turbine and configured to gasify the liquid natural gas using exhaust air exiting the turbine.

16. A gas turbine engine system, comprising:
a first compressor configured to compress an inlet air flow to produce a first outlet air flow at a first pressure;
an intercooler coupled to the first compressor and configured to cool the first outlet air flow exiting the first compressor to produce a second outlet air flow; wherein a cooled intermediate working fluid is used in the intercooler to cool the first outlet air flow exiting the first compressor;
a second compressor coupled to the intercooler and configured to compress the second outlet air flow exiting the intercooler to produce a third outlet air flow at a second pressure;
a combustor coupled to the second compressor and configured to combust a mixture of fuel and the third outlet air flow exiting the second compressor to increase an operating temperature of the third outlet air flow; and
a turbine coupled to the combustor and configured to expand combustion exhaust gas exiting from the combustor to generate power.

17. The system of claim 16, further comprising a chiller coupled to the first compressor and configured to cool the inlet air flow directed to the first compressor using the cooled intermediate working fluid.

18. The system of claim 17, further comprising an air dryer coupled to the chiller and configured to remove water vapor from the inlet air flow exiting the chiller.

19. The system of claim 17, further comprising at least one distribution valve coupled to the chiller and the intercooler and configured to control flow of the cooled intermediate working fluid.

20. The system of claim 19, further comprising a control unit communicatively coupled to the distribution valve and configured to control flow of the cooled intermediate working fluid.

21. The system of claim 16, wherein the turbine is coupled to the first and second compressor and configured to drive the first and second compressor.

22. The system of claim 21, further comprising a working fluid heater coupled to the turbine and configured to produce a heated intermediate working fluid.

23. The system of claim 22, further comprising a fan coupled to the working fluid heater and configured to direct inlet air to the working fluid heater.

24. The system of claim 22, further comprising a heat exchanger coupled to the working fluid heater and configured to gasify the liquid natural gas using the heated intermediate working fluid exiting the working fluid heater
